(19) United States
(12) Patent Application Publication
(10) Pub. No.: US 2023/0329195 A1
(43) Pub. Date: Oct. 19, 2023

(54) BIRD FEEDER SUPPORT

(71) Applicant: Carl FOWLER, Chorley (GB)

(72) Inventor: Carl FOWLER, Chorley (GB)

(21) Appl. No.: 17/720,287

(22) Filed: Apr. 13, 2022

(51) Int. Cl. A01K 39/012; F16B 1/00; F16M 13/02

(52) U.S. Cl. CPC A01K 39/0125; F16B 1/00; F16M 13/022; F16B 2001/0035

(57) ABSTRACT

A bird feeder support for preventing or inhibiting the movement or swinging of a bird feeder when suspended from, or otherwise supported by, a support pole. The bird feeder support comprises a mount, such as a tube and screw, or a coil arrangement, which is releasably connectable to a support pole. A strut extends from the mount and holds at its distal end, a support in the form of a ring or a C-shaped member. The ring or C-shaped member partially or fully surrounds a part of a tubular bird feeder suspended from the support pole, so as to prevent it from swinging in the wind. Alternatively, the ring or C-shaped member can be used to support a dish bird feeder, also in a substantially fixed relationship to the support pole.

### FIELD

This invention relates to bird feeder supports.

### BACKGROUND

It is a popular hobby for people to feed wild birds in their gardens and other locations so as to encourage birds into the garden for environmental and recreational purposes. This can be done by using a bird feeder, which is a receptacle that contains a quantity of feed of varying types—so as to attract different species of birds. Commonly, wild birds are fed using seeds, nuts or suet balls, which are retained in a receptacle that protects the contents from the elements, but which nevertheless enables the birds to feed from it.

A typical bird feeder has a generally tubular shaped, reticulated or apertured main body, which gives the birds access to feed contained within the interior of the tube. Depending on the size and shape of the holes in the reticulated main body, the tube can be filled with seed, nuts or other feed, and birds can peck through the apertures in the reticulated main body so as to gain access to the feed. The tube-type bird feeder typically has an upper cap, which sheds rainwater away from the feed within the container. The upper cap typically has an eye or a hook from which the feeder can be suspended. The feed is prevented from falling out of the bottom of the tube by a lower cap of a similar construction to the upper cap and the lower cap can also have perch features for birds to stand on whilst feeding, although this is not necessary as most wild birds, and in particular song birds, can simply grip onto the reticulated tube to feed through it.

Another type of bird feeder is a bird table, which is simply an elevated platform upon which food can be placed. A bird table typically has a roof to shed rainwater away from the table's surface—thereby protecting the food from the elements and thus being spoiled.

A further type of bird feeder is the dish-type bird feeder, which generally comprises a bowl into which feed can be placed either directly, or on various support means, such as wire racks or domes. A rainwater-shedding cover is typically provided in much the same way as a bird table—so as to protect the feed from the elements.

### BRIEF SUMMARY

The known bird feeders as described above and elsewhere are typically suspended from above, or supported from below and this provides a stable arrangement in fair weather conditions. However, when the weather turns windy, a suspended bird feeder tends to blow around quite erratically in the wind making it difficult, if not impossible, for birds to land on it. More importantly, the feed is often scattered from a tubular feeder in windy conditions due to the vigorous shaking action of the feeder, which is not only wasteful, but can also attract vermin. Bird tables are likewise susceptible to blowing over and/or feed blowing off them in strong winds. Bowl-type bird feeders, which can either be of the suspended, or supported from below, type, suffer the same drawbacks as the tubular feeder and bird table described above, respectively.

A need therefore exists for a solution to this problem, which stabilises the feeder in windy conditions, whilst still permitting birds to feed from the feeder relatively uninhibited. This invention aims to provide such a solution.

Aspects of the invention are set forth in the appended independent claim or claims. Preferred and/or optional features are set forth in the appended dependent claims.

A bird feeder support in accordance with the invention comprises: a mount comprising a tube, or a part-tubular body, which engages with a support pole for a bird feeder; a support; and a strut connecting the mount to the support, wherein the support comprises a ring adapted, in use, to surround a bird feeder, or a C-shaped member adapted, in use, to at least partially surround the bird feeder, such that, in use: when used in conjunction with a tubular bird feeder, the ring or C-shaped body is adapted, in use, to have an inner diameter that is larger than the outer diameter of the tubular bird feeder, such that the tubular bird feeder is axially receivable within the ring or C-shaped body; and when used in conjunction with a dish bird feeder comprising an annular recess, the ring or C-shaped body is adapted, in use, to provide a push fit or friction fit connection of the dish bird feeder to the support; such that when the bird feeder support is used in conjunction with the tubular bird feeder or the dish bird feeder, movement of the tubular bird feeder within the plane of the support is inhibited and/or prevented.

The mount suitably comprises a tube, or a part-tubular body, which engages with a support pole for the bird feeder. The tube, or a part-tubular body, may comprise releasable clamping means for clamping the tube, or a part-tubular body, to the support pole, thereby forming a friction-fit connection that prevents and/or inhibits movement of the mount relative to the support pole. The releasable clamping means suitably comprises an over-centred clamp, or a screw-threaded boss that can be screwed relative to the tube, or a part-tubular body so as to engage the support pole.

Additionally or alternatively, the mount may comprise a coil whose inner diameter is less than the outer diameter of a support pole for the bird feeder, such that the coil is resiliently expandable over the support pole, so as to form a friction-fit connection that prevents and/or inhibits movement of the mount relative to the support pole.

Suitably, the support comprises a ring. The ring is suitably dimensioned so as to accommodate a bird feeder within it and by surrounding the bird feeder, movement of the bird feeder within the plane of the ring can be inhibited and/or prevented. In other embodiments, the support comprises a generally C-shaped member, which forms a clevis or yoke into which the body of a bird feeder can be fitted. By engaging or capturing the bird feeder thus, it can be stabilised. In yet further embodiments of the invention, the support comprises a magnet, which is magnetically attractable to a metal component of the bird feeder. Thus, the support can be magnetically affixed to the bird feeder so as to stabilise it.

Suitably, the ring, where provided, is circular. The ring, where provided, or the generally C-shaped body can comprise one or more struts extending radially outwardly therefrom.

In certain embodiments, the support comprises an inner ring, an outer ring and one or more struts connecting the inner ring to the outer ring.

The strut or struts suitably comprise a metal bar extending between the mount and the ring. The strut connecting the inner ring to the outer ring may be an extension of the strut extending between the mount and the ring.

Where the bird feeder is a tubular bird feeder, the inner diameter of the ring is suitably larger than the outer diameter of the tubular bird feeder, such that the tubular bird feeder is axially receivable within the ring.

Where the bird feeder is a dish bird feeder the dish bird feeder suitably comprises an annular recess into which the ring is a push fit or friction fit. The dish bird feeder may comprise a dish-shaped main body portion for receiving a quantity of feed. It may also comprise: a rainwater-shedding roof covering the dish-shaped main body portion. The rainwater-shedding roof is suitably manufactured from a transparent plastics material, and this has the advantage of enabling birds and observers to easily inspect the contents of the feeder. The rainwater-shedding roof is suitably detachably affixable to the dish bird feeder. This may be accomplished by using clips or catches, by providing a magnetic connection between the roof and the dish bird feeder, or by providing clip-like formations for resiliently connecting the roof to the dish feeder. A mesh insert may be provided, which is locatable within the dish-shaped main body portion for supporting the feed off a base wall of the dish-shaped main body portion. A dome insert may be provided, which is locatable within the dish-shaped main body portion for supporting the feed off a base wall of the dish-shaped main body portion. A reticulated or apertured tube may be provided that is mountable on a periphery of the dish-shaped main body portion for retaining the feed within and/or above the dish-shaped main body portion.

The rainwater-shedding roof is suitably detachably connectable to the dish-shaped main body portion. This may be by means of a magnetic connection interposed between a portion of the rainwater-shedding roof and the dish-shaped main body portion. It may also be by way of a clip connection between a portion of the rainwater-shedding roof and a dish-shaped main body portion. Preferably, the clip connection comprises a ridge of the rainwater-shedding roof being resiliently receivable within a complimentary grove of the dish-shaped main body portion or vice versa.

A second aspect of the invention provides a support comprising a base, a support pole extending substantially vertically upwardly from the base and one or more bird feeder supports as described herein.

The support pole suitably comprises one or more limbs projecting therefrom, from which limb or limbs, a bird feeder can, in use, be suspended.

A third aspect of the invention provides a kit comprising a support, a bird feeder support as described herein, and a bird feeder.

A tubular bird feeder may be provided, which comprises an upper cap with a hook or eye to which it is connected to the limb by a cord or other linkage, a reticulated or apertured tubular main body portion for retaining a quantity of feed connected at, or near to its upper end to the upper cap, and a lower cap affixed to a lower end of the reticulated or apertured tubular main body portion, wherein an outer diameter of reticulated or apertured tubular main body portion is less than an inner diameter of the ring, and wherein the centre of the ring is substantially vertically aligned with a part of the limb from which the tubular bird feeder is suspended, and wherein the bird feeder support is adjustable so as to locate the ring around the reticulated or apertured tubular main body portion so as to stabilise it relative to the support pole.

Additionally or alternatively, a dish bird feeder as described herein may be provided.

### BRIEF DESCRIPTION OF THE DRAWINGS

Embodiments of the invention shall now be described, by way of example only, with reference to the accompanying drawings in which:

FIG. 1 is a schematic, perspective view of a first embodiment of a bird feeder support in accordance with the invention;

FIG. 2 is a schematic, perspective view of a bird feeder arrangement incorporating different embodiments of the bird feeder support in accordance with the invention;

FIG. 3 is a partial, close-up view of FIG. 2;

FIG. 4 is a schematic, exploded view showing how a dish-type bird feeder can be supported by a bird feeder support in accordance with the invention;

FIG. 5 is a cross-sectional view of the bird feeder shown in FIG. 4, assembled;

FIG. 6 is a schematic, perspective view from below of the bird feeder of FIGS. 4 and 5 and;

FIG. 7 is a schematic, perspective view of a multi-support bird feeder in accordance with the invention.

### DETAILED DESCRIPTION OF EMBODIMENTS

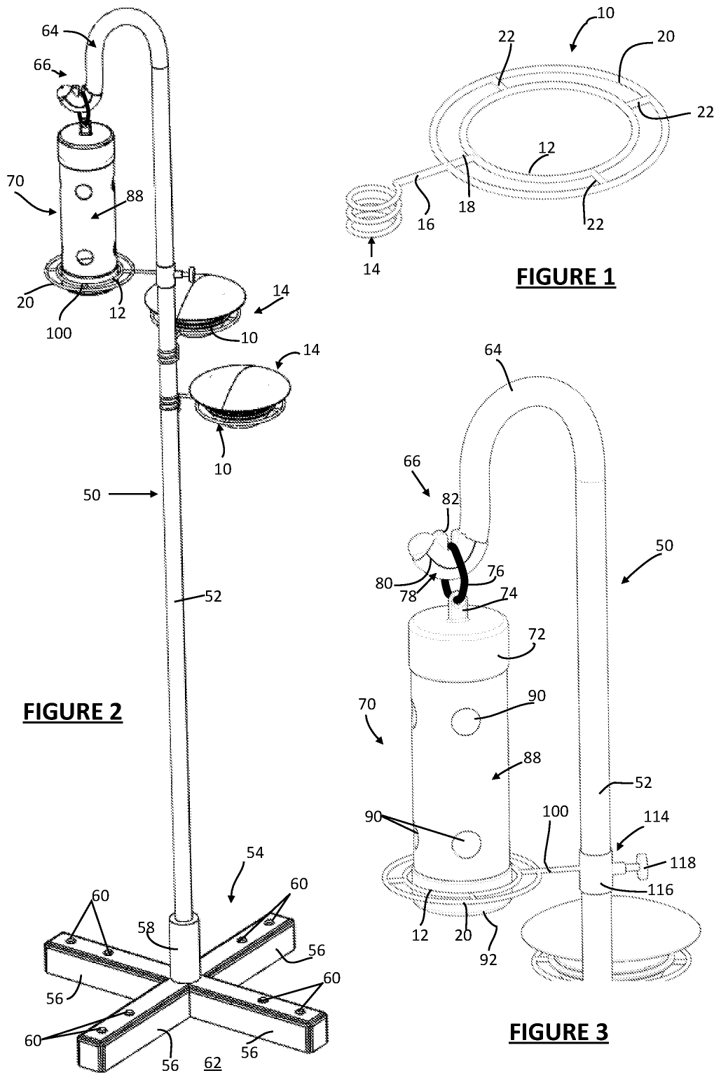

FIG. 1 of the drawings shows a bird feeder support in accordance with one embodiment of the invention. The bird feeder support 10 comprises a ring 12 and a mount 14 in the form of a metal coil. A strut 16 interconnects the mount and the ring 12. In the illustrated embodiment, the strut 16 is simply a straight extension of the coil 14, which are formed from metal wire. The distal end 18 of the strut 16 is braised, welded or otherwise affixed to the ring 12 to form a unitary structure. Surrounding the ring 12 is an outer ring 20, which is maintained in a fixed relationship to the ring 12 by a set of struts 22 which extend radially outwardly from the ring 12 to meet the outer ring 20. The struts 22 are welded, braised or otherwise joined at both ends to the inner ring 12 and the outer ring 20.

Referring now to FIG. 2 of the drawings, it can be seen how the bird feeder support 10 previously described can be mounted on a support 50. The support 50 comprises an elongate, vertical pole 52, which extends upwardly from a base 54. The base 54 is of a generally cruciform form having four limbs 56 extending outwardly from a central point at right angles. A tube 58 extends up from the base 54, which slidingly receives a lower end of the support pole 52. Each of the limbs 56 of the base 54 have through apertures 60 therein for receiving stabilising screws of pegs so that the base 54 can be secured to a grass, concrete or other substrate surface. The support 50 therefore provides a vertical pole 52 mounted stably on the floor 62. The upper end of the support pole 52 curves over into a crook-like formation 64, terminating in a hook formation 66 from which a tubular bird feeder 70 can be suspended. The bird feeder support 10 or supports can be slid over the pole 52 from the hook end to a desired position along the length of the pole 52, and can be rotated about an axis of the pole 52 to obtain a desired rotational and axial configuration, as shown in FIG. 2 of the drawings.

The bird feeder support 10 is retained in a fixed relationship to the support pole 52 by virtue of the inner diameter of the coil 14 being slightly less than the outer diameter of the support pole 52. This means that the coil 14 has to be stretched or enlarged somewhat to fit over the pole 52, and thus a gripping or friction-fit is obtained between the mount 14 and the support pole 52. In other embodiments, as shown in FIGS. 3, 4 and 6 of the drawings, the friction fit is attained by the mount 114 comprising a tube 116 that slides over the support pole 52, and which has a screw 118 that screws in to engage the support pole 52—thereby retaining the bird feeder support 10 in a fixed axial and/or radial position relative to the support pole 52.

As can be seen, in particular from FIGS. 2 and 3 of the drawings, the inner diameter of the ring 12 is slightly larger than the outer diameter of the tubular bird feeder 70. This means that the tubular bird feeder 70 can be located co-axially within the ring 12 thereby stabilising it relative to the support pole 52. Meanwhile, the outer ring 20 provides a convenient perch for birds (not shown) to feed from the tubular bird feeder 70.

The tubular bird feeder 70 has an upper cap 72, which has an eyelet or ring 74, which enables the feeder 70 to be suspended from the hook part of the support 50 by a loop, tie or by some other means 76. To further stabilise the feeder 70 relative to the support pole 52, a rubber or elastomeric sleeve 78, for example manufactured from silicone rubber, is slipped over the hook portion 66 of the support pole 52. The sleeve 78 has a split line 80, which facilitates locating the sleeve 78 on the support pole 52, and it also has a recessed web 82, which recess retains the loop or tie 76 previously described to prevent it from slipping off the end of the support pole 52. In addition, because the sleeve 78 is manufactured from an elastomeric material, a certain amount of friction/gripping is possible between the loop 76 and the recessed web 82 thereby further stabilising the feeder 70.

The feeder 70 has a main body 88, which is manufactured, in the illustrated embodiment, from transparent plastics material, and which has apertures 90 therein through which birds can feed. However, in many tubular bird feeders, the main body 88 is manufactured from wire mesh thereby providing a reticulated structure through which the birds can feed. The tubular bird feeder 70 is completed by a lower cap 92, which slips onto the main body 88 thus preventing feed within the main body 88 from simply falling onto the floor below.

It will be appreciated from FIG. 3 in particular that the provision of the bird feed feeder support greatly stabilises the tubular bird feeder from movement due to windage, etc.

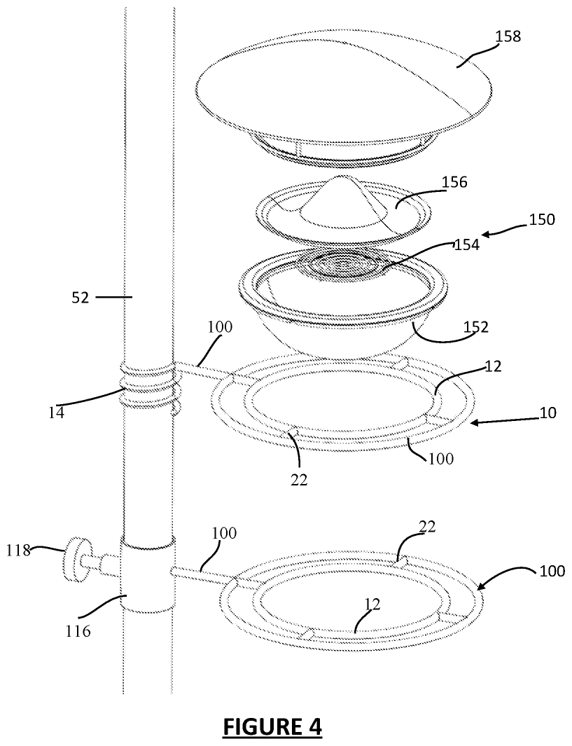

Turning now to FIGS. 4, 5 and 6 of the drawings, the bird feeder support 10 previously described can also be used to support a dish-type bird feeder 150. The dish-type bird feeder 150 has a generally dish shaped main body 152, which fits snuggly within the ring 12. It will be appreciated that either the coil-mount version shown in FIG. 1 of the drawings could be used; or indeed the screw-threaded version of the bird feeder support 100 could be shown, as illustrated in FIGS. 2 and 3 of the drawings.

The dish bird feeder 150 has various optional accessories, including a mesh plate 154, which sits inside the bowl and supports any feed within the bowl above the base wall of the main body 152. Additionally or alternatively, a dome 156 may be provided, and this is particularly useful where the feed is suet balls and the like. A roof 158 may also be provided to shed rainwater off any feed retained by the main body 152.

FIG. 5 shows how the dish bird feeder of FIG. 4 can be assembled. It can be seen that the main body 152 is generally dish shaped and has a drainage aperture 160 in the bottom of it to enable water to drain from the main body 152 and also to allow air into the main body below the feed (not shown). The wire mesh 154 simply drops into the main body 152 and creates a small gap 162 below the mesh 154 so that the feed (not shown) placed on top of the mesh can be aerated and drain effectively as will be readily apparent.

Where it is intended to use the feeder in conjunction with larger feed, such as suet balls, it is advantageous to use a dome 156, which tends to urge such feed radially outwardly towards where the birds (not shown) would stand. The dome 156 is therefore designed in such a way as to clip or push fit into the periphery of the main body 152 so that it remains securely in place, in use. The roof 158 previously described has a generally dome-shape and is supported by legs 164 above the bird feeder support. The lower ends of the legs are connected to a ring 166, which has a ridge 168 that engages with a complimentary groove 190 of the main body 152. This creates a clip-like connection between the roof 158 and the main body 152, which also traps the dome 156 therebetween.

The main body of the bowl 152 also has a groove 172, which is a friction fit with the ring 12 of the bird feeder support. It will be appreciated from the foregoing that the whole assembly can simply be clicked together in a convenient fashion, which facilitates assembly, disassembly, maintenance, repair, etc.

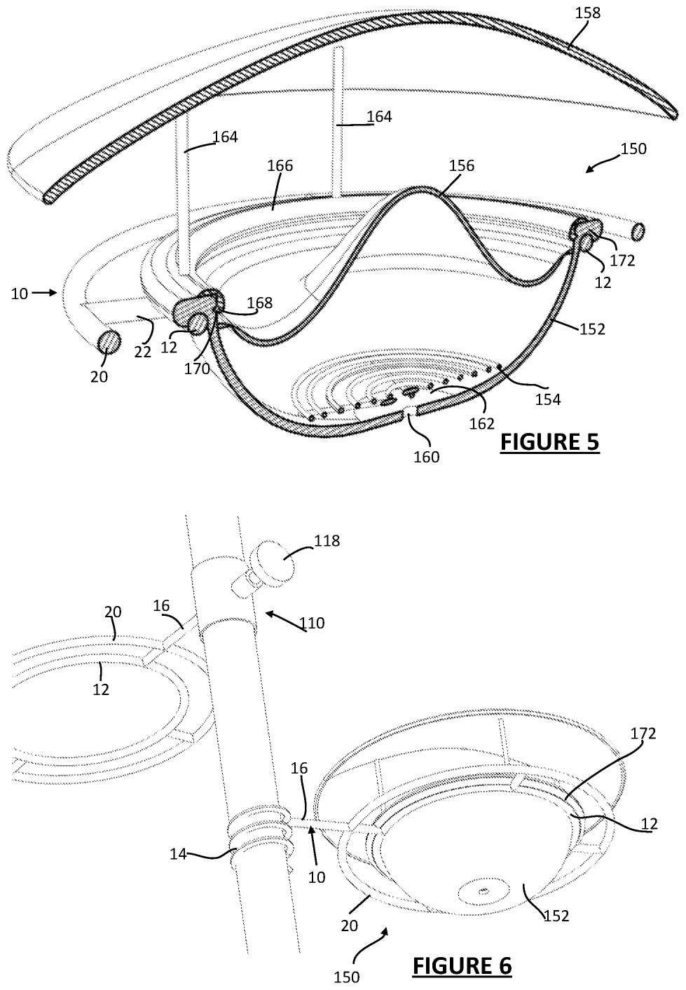

FIG. 6 simply shows the assembly from below and, in particular, how the ring 12 engages the groove 172 of the main body 152 of the dish feeder 150.

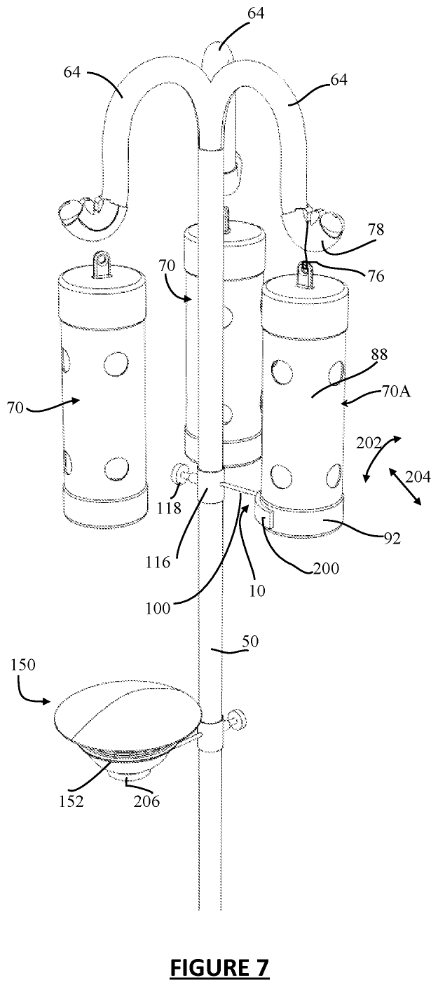

Referring now to FIG. 7 of the drawings, a bird feeder system in accordance with the invention comprises a support pole 50, which has three crook-like formations 64 at the top of it, for respectively supporting bird feeders 70 in the manner previously described. One of the bird feeders 70A is suspended from the crook-like formations 64 by a wire 76 that is held in position by the rubber sleeve 78. An alternative embodiment of a stabilising device 10 is shown, which has a tube portion 116 that engages the support pole 50 and a locking screw 118 for holding it at a desired axial and radial position relative to the support pole 50. A strut 100 connects the tube 116 surrounding the support pole 50 to a generally C-shaped support member 200. The generally C-shaped support member 200 is a snug fit with the lower end cap 92 of the bird feeder 78 and this serves to stabilise it against movement in the direction indicated by arrow 202. In a preferred embodiment of the invention, the generally C-shaped support 200 comprises a magnet, which magnetically connects to the end cap 92, where this is made of metal, or where it comprises a metal insert. A magnetic, or even a friction-fit engagement between the generally C-shaped support 200 and the end cap 92, or even the main body 88 of the feeder 70A will serve to stabilise the feeder 70A against movement in the direction indicated by arrow 204 as well.

A slight variation of the dish support previously described comprises a generally cylindrical disc 206, which contains a magnet (not visible), which magnetically attracts and connects to the bowl 152 of a bowl feeder 150.

What is claimed is:

1. A bird feeder support, comprising:
a mount comprising a tube, or a part-tubular body, which engages with a support pole for a bird feeder;
a support; and
a strut connecting the mount to the support
wherein the support comprises a ring adapted, in use, to surround a bird feeder, or a C-shaped member adapted, in use, to at least partially surround the bird feeder, such that, in use:
when used in conjunction with a tubular bird feeder, the ring or C-shaped body is adapted, in use, to have an inner diameter that is larger than the outer diameter of the tubular bird feeder, such that the tubular bird feeder is axially receivable within the ring or C-shaped body; and
when used in conjunction with a dish bird feeder comprising an annular recess, the ring or C-shaped body is adapted, in use, to provide a push fit or friction fit connection of the dish bird feeder to the support;
such that when the bird feeder support is used in conjunction with the tubular bird feeder or the dish bird feeder, movement of the tubular bird feeder within the plane of the support is inhibited and/or prevented.

2. The bird feeder support of claim 1, wherein the tube, or a part-tubular body, comprises releasable clamping means for clamping the tube, or a part-tubular body, to the support pole, thereby forming a friction-fit connection that prevents and/or inhibits movement of the mount relative to the support pole.

3. The bird feeder support of claim 2, wherein the releasable clamping means comprises an over-centred clamp.

4. The bird feeder support of claim 2, wherein the releasable clamping means comprises a screw-threaded boss that can be screwed relative to the tube, or a part-tubular body so as to engage the support pole.

5. The bird feeder support of claim 1, wherein the mount comprises a coil whose inner diameter is less than the outer diameter of a support pole for the bird feeder, such that the coil is resiliently expandable over the support pole, so as to form a friction-fit connection that prevents and/or inhibits movement of the mount relative to the support pole.

6. The bird feeder support of claim 1, wherein the support comprises an inner ring or C-shaped body, an outer ring surrounding the inner ring or C-shaped body, and one or more struts connecting the inner ring or C-shaped body to the outer ring.

7. The bird feeder support of claim 1, wherein the support comprises a magnet, which is magnetically attractable to a metal component of the bird feeder.

8. The bird feeder support of claim 1, wherein the generally C-shaped support comprises a magnet, which magnetically connects to a metal end cap, a metal insert of an end cap, of the tubular bird feeder; or to the bowl of a bowl feeder.

9. The bird feeder support of claim 1, wherein the dish bird feeder comprises a dish-shaped main body portion for receiving a quantity of feed and any one or more of the group comprising:
a rainwater-shedding roof covering the dish-shaped main body portion;
a mesh insert locatable within the dish-shaped main body portion for supporting the feed off a base wall of the dish-shaped main body portion;
a dome insert locatable within the dish-shaped main body portion for supporting the feed off a base wall of the dish-shaped main body portion; and
a plastics tube mountable on a periphery of the dish-shaped main body portion for retaining the feed within and/or above the dish-shaped main body portion; and a reticulated tube mountable on a periphery of the dish-shaped main body portion for retaining the feed within and/or above the dish-shaped main body portion.

10. The bird feeder support of claim 9, wherein the rainwater-shedding roof is detachably connectable to the dish-shaped main body portion.

11. The bird feeder support of claim 10, wherein the rainwater-shedding roof is detachably connectable to the dish-shaped main body portion by means of a magnetic connection interposed between a portion of the rainwater-shedding roof and the dish-shaped main body portion.

12. The bird feeder support of claim 10, wherein the rainwater-shedding roof is detachably connectable to the dish-shaped main body portion by means of a clip connection interposed between a portion of the rainwater-shedding roof and the dish-shaped main body portion.

13. The bird feeder support of claim 12, wherein the clip connection comprises a ridge of the rainwater-shedding roof being resiliently receivable within a complementary groove of the dish-shaped main body portion or vice-versa.

14. The bird feeder support of claim 10, wherein the rainwater-shedding roof is manufactured from a transparent plastics material.

15. A support comprising a base, a support pole extending substantially vertically upwardly from the base and one or more bird feeder supports according to claim 1.

16. The support of claim 15, wherein the support pole comprises a limb projecting therefrom, from which limb, a tubular bird feeder can, in use, be suspended.

17. The support of claim 16, comprising a tubular bird feeder, the tubular bird feeder comprising an upper cap with a hook or eye to which it is connected to the limb by a cord or other linkage, a reticulated or apertured tubular main body portion for retaining a quantity of feed connected at, or near to its upper end to the upper cap, and a lower cap affixed to a lower end of the reticulated or apertured tubular main body portion, wherein an outer diameter of reticulated or apertured tubular main body portion is less than an inner diameter of the ring, and wherein the centre of the ring is substantially vertically aligned with a part of the limb from which the tubular bird feeder is suspended, and wherein the bird feeder support is adjustable so as to locate the ring around the reticulated or apertured tubular main body portion so as to stabilise it relative to the support pole.

18. The support of claim 16, comprising a rubber or elastomeric sleeve, which is slipped over a hook portion of the support pole.

19. The support of claim 18, wherein the sleeve has a split line, which facilitates locating the sleeve on the support pole and a recessed web, which retains a loop or tie from which the bird feeder is suspended.

20. The support of claim 15, further comprising the dish bird feeder of claim 6.
